(19) United States
(12) Patent Application Publication
(10) Pub. No.: US 2016/0149395 A1
(43) Pub. Date: May 26, 2016

(54) LIQUID LEVEL CONTROL SWITCH DEVICE AND THE CONTROL CIRCUIT THEREOF

(71) Applicant: Sunny International Co., Ltd., Jiangsu (CN)

(72) Inventors: Zhaowen Fan, Nantong (CN); Caipei Yue, Nantong (CN)

(73) Assignee: Sunny International Co., Ltd., Jiangsu (CN)

(21) Appl. No.: 14/699,385

(22) Filed: Apr. 29, 2015

(30) Foreign Application Priority Data
Nov. 20, 2014 (CN) 2014106653603

(51) Int. Cl. H02H 5/08; G01F 23/26

(52) U.S. Cl. CPC H02H 5/08; G01F 23/26

(57) ABSTRACT

A liquid level control switch device includes a liquid level sensor and a contactor, in which the liquid level sensor includes a liquid level electrode, a casing, a control circuit board and a power supply lead wire, in which the liquid level electrode and the control circuit board are electrically connected and the control circuit board transmits measurement pulse signals, in accordance with the sampling frequency, to the liquid level electrode and collects the liquid level signals sensed by the liquid level electrode; and the contactor is arranged in the casing, and a coil of the contactor is electrically connected with the control circuit board, which controls the closing and opening operations of the contactor, according to the collected liquid level signals.

### TECHNICAL FIELD

The present invention relates to a liquid level control device, especially relates to a liquid level control switch device that uses pulse signals to measure liquid levels. The device is compact in structure, and the electrode is easy to clean.

### BACKGROUND TECHNOLOGY

Liquid level control switch devices are common detection devices in the field of liquid level detection. Liquid level control switch devices of the existing technology have many shortcomings and deficiencies: the power line of the water pump and the power line of the liquid level control switch device need to be respectively arranged; two power lines overlap with each other; the costs of operations are increased; liquid level electrodes and the control circuit board are separately packaged; the structure is complex; the liquid level electrode and the control circuit are connected by a long conductor wire; electromagnetic interference in the lines can cause the control circuit to produce incorrect signals; the liquid level electrodes are arranged inside the casing of the liquid level control switch device, which is inconvenient for the cleaning of the electrodes; continuously providing sampling currents to the liquid level electrode, making the induction electrode prone to electrolytic corrosion, influencing the accuracy of measurements.

### SUMMARY OF THE INVENTION

With respect to the problems existing in the prior art, an object of the invention is to provide liquid level control switch devices that use pulse signals to sample liquid levels. The devices are compact in structures and are convenient for cleaning the electrodes. The invention also provides control circuits for the control of the liquid level control switch devices.

The present invention provides liquid level control switch devices, which comprise a liquid level sensor and a contactor. The designs have the following features:

The liquid level control switch device comprises a liquid level electrode (1), a casing (2), a control circuit board (3), and a power supply lead wire (4). The casing (2) comprises a chamber body having a bottom, a side wall, and an open top. The control circuit board (3) is sealingly disposed inside the casing (2). A lower portion of the casing (2) is provided with a first installation hole (21), a second installation hole (22), and the third installation hole (23) for installations of liquid level electrodes.

The liquid level electrode (1) for sensing liquid levels comprises a first electrode (11) for sensing high liquid level, a second electrode (12) for sensing low liquid level, and a third electrode (13) for connection a common terminal.

A partial length of each of the first electrode (11), the second electrode (12) and the third electrode (13) is sealing arranged, respectively, in the first installation hole (21), second installation hole (22), and the third installation hole (23).

The first electrode (11), the second electrode (12), the third electrode (13), and the control circuit board (3) are electrically connected.

The control circuit board (3) sends, according to sampling frequencies, measurement signals to the first electrode (11) and the second electrode (12), and collects liquid level signals sensed by the first electrode (11) and the second electrode (12).

A plastic separation board (24) is disposed between the first electrode (11) and the second electrode (12) to prevent electromagnetic interference.

The control circuit board (3) and the power supply lead wire (4) are electrically connected.

The contactor is disposed in the casing (2), and a coil of the contactor is electrically connected with the control circuit board (3).

The contactor is installed inside the casing (2). The coil of the contactor and the control circuit (3) are electrically connected. The control circuit board (3) controls the closing and opening operations of the contactor, according to the liquid level signals collected by the first electrode (11) and the second electrode (12).

The present invention includes the following further improved embodiments:

Furthermore, the liquid level control switch device also comprises a T adaptor (5). The T adaptor (5) comprises an electric wire connector (51), a switch connector (52), and an output socket (53).

A first conductor (41) serving as a common ground, a second conductor serving as a null line, at least one third conductor (43) serving as a live wire, at least one fourth conductor (44) serving as a live wire, and a fifth conductor (45) serving as a null line are disposed in the T-shaped connector.

The first conductor (41), and the second conductor (42) pass through the electric wire connector (51) and the output socket (53). The third conductor (43) passes through the electric wire connector (51) and the switch connector (52). The fourth conductor (44) passes through the switch connector (52) and the output socket (53). The fifth conductor (45) and the second conductor (42) are electrically connected and pass through the switch connector (52). The switch connector (52) of the T adaptor (5) and the power supply lead wire (4) of the liquid level sensor are electrically connected. The third conductor (43) and the fourth conductor (44) in the switch connector (52) connects with the contactor.

Furthermore, the liquid level electrode (1) is made of stainless steel.

Furthermore, the liquid level electrode (1) has a diameter of 3-5 mm and a length exposed outside the casing (2) is 2-7 mm.

Furthermore, the control circuit board (3) is provided with a step-down power supply, a first amplification circuit (61), a second amplification circuit (62), a microprocessor (65) and a triode (63), and a contactor (64). The step-down power supply provides electric power to the first amplification circuit (61), the second amplification circuit (62), the microprocessor (65) and the triode (63).

The first electrode (11) for high liquid level sensing and an input of the first amplification circuit (61) are electrically connected. An output of the first amplification circuit is electrically connected with a first input of the microprocessor (65).

The second electrode (12) for low liquid level sensing is electrically connected with an input of the second amplification circuit (62). An output of the second amplification circuit (62) is electrically connected with the second input of the microprocessor (65).

A first input of the microprocessor (65) is electrically connected with the triode (63). A collector of the triode (63) is electrically connected with the step-down power supply via the coil of the contactor (64).

A second output and a third output of the first amplification circuit (61) are used to output pulse signals and are, respectively, electrically connected with the input of the first amplification circuit (61) and the input of the second amplification circuit (65).

Furthermore, the first amplifier circuit includes a first operational amplifier (U2A) and the first voltage comparator (U1A). The output of the first operational amplifier (U2A) and the non-inverting input of the first voltage comparator (U1A) are electrically connected.

A second diode (D2) and a third diode (D3) are connected in series in the same direction. The cathode of the second diode (D2) and the third diode (D3) is electrically connected with output of the step-down power supply, and anode of the second diode (D2) and the third diode (D3) is grounded.

The two ends of the second diode (D2) and the third diode (D3) are, respectively, connected in parallel with a third resistor (R3) and a fifth resistor (R5).

The connection between the second diode (D2) and the third diode (D3) is grounded via a fourth capacitor (C4).

The input of the first amplification circuit is connected, via the connection between the second diode (D2) and the third diode (D3), with the non-inverting input of the first operational amplifier (U2A).

The seventh resistor (R7) is connected in series with the sixth resistor (R6). One end of the seventh resistor (R7) and the sixth resistor (R6) is connected with an output of the first operational amplifier (U2A), and the other end of the seventh resistor (R7) and the sixth resistor (R6) is grounded. The connection between the seventh resistor (R7) and the sixth resistor (R6) is electrically connected with an inverting input of the first operational amplifier (U2A).

The first resistor (R1) and the second resistor (R2) are connected in series. The other end of the second resistor (R2) is connected with output of the step-down power supply, and the other end of the first resistor (R1) is grounded.

A first capacitor (C1) is connected in parallel with both ends of the first resistor (R1).

The connection between the first resistor (R1) and the second resistor (R2) is connected with the inverting input of the first voltage comparator (U1A).

Furthermore, the second amplification circuit comprises a second operational amplifier (U2B) and a second voltage comparator (U1B). The output of the second operational amplifier (U2B) is electrically connected with a non-inverting input of the second voltage comparator (U1B).

The fourth diode (D4) and the fifth diode (D5) are connected in series in the same direction. The cathode of the fourth diode (D4) and the fifth diode (D5) is connected with output of the step-down power supply, and the anode of the fourth diode (D4) and the fifth diode (D5) is grounded.

Both ends of the fourth diode (D4) and the fifth diode (D5) are respectively connected in parallel with a tenth resistor (R10) and an eleventh resistor (R11).

The connection between the fourth diode (D4) and the fifth diode (D5) is grounded via an eighth capacitor (C8).

The input of the second amplification circuit is electrically connected, via the connection between the fourth diode (D4) and the fifth diode (D5), with the non-inverting input of the second operational amplifier (U2B).

The thirteenth resistor (R13) and the twelfth resistor (R12) are connected in series. One end of the thirteenth resistor (R13) and the twelfth resistor (R12) is electrically connected with output of the second operational amplifier (U2B), and the other end of the thirteenth resistor (R13) and the twelfth resistor (R12) is grounded. The connection between the thirteenth resistor (R13) and the twelfth resistor (R12) is electrically connected with the inverting input of the second operational amplifier (U2B).

The connection between the first resistor (R1) and the second resistor (R2) is electrically connected with the inverting input of the second voltage comparator (U1B).

The present invention provides a control circuit for controlling the liquid level control switch device described above. The key design features include a first operational amplifier (U2A), a first voltage comparator (U1A), a second operational amplifier (U2B), a second voltage comparator (U1B), a microprocessor (U3), a triode (Q1), and a step-down power supply (U4).

The second diode (D2) and the third diode (D3) are connected in series in the same direction. The cathode of the second diode (D2) and the third diode (D3) is electrically connected with output of the step-down power supply, and the anode of the second diode (D2) and the third diode (D3) is grounded.

Both ends of the second diode (D2) and the third diode (D3) are respectively connected in parallel with the third resistor (R3) and the fifth resistor (R5). The connection between the second diode (D2) and the third diode (13) is grounded via the fourth capacitor (C4).

The input of the first amplification circuit is electrically connected, via the connection between the second diode (D2) and the third diode (D3), with the non-inverting input of the first operational amplifier (U2A).

The seventh resistor (R7) and the sixth resistor (R6) are connected in series. One end of the seventh resistor (R7) and the sixth resistor (R6) is electrically connected with output of the first operational amplifier (U2A), and the other end of the seventh resistor (R7) and the sixth resistor (R6) is grounded. The connection between the seventh resistor (R7) and the sixth resistor (R6) is electrically connected with the inverting input of the first operational amplifier (U2A). The output of the first operational amplifier (U2A) is electrically connected with non-inverting input of the first voltage comparator (U1A).

The fourth diode (D4) and the fifth diode (D5) are connected in series in the same direction. The cathode of the fourth diode (D4) and the fifth diode (D5) is electrically connected with output of the step-down power supply, and the anode of the fourth diode (D4) and the fifth diode (D5) is grounded.

Both ends of the fourth diode (D4) and the fifth diode (D5) are respectively connected in parallel with the tenth resistor (R10) and the eleventh resistor (R11). The connection between the fourth diode (D4) and the fifth diode (D5) is grounded via the eighth capacitor (C8).

The input of the second amplification circuit is electrically connected, via the connection between the fourth diode (D4) and the fifth diode (D5), with the non-inverting input of the second operational amplifier (U2B).

The thirteenth resistor (R13) and the twelfth resistor (R12) are connected in series. One end of the thirteenth resistor (R13) and the twelfth resistor (R12) is electrically connected with output of the second operational amplifier (U2B), and the other end of the thirteenth resistor (R13) and the twelfth resistor (R12) is grounded. The connection between the thirteenth resistor (R13) and the twelfth resistor (R12) is electrically connected with the inverting input of the second operational amplifier (U2B).

The output of the second operational amplifier and non-inverting input of the second voltage comparator (U1B) are electrically connected.

The first resistor (R1) and the second resistor (R2) are connected in series. The other end of the second resistor (R2) is electrically connected with output of the step-down power supply, and the other end of the first resistor (R1) is grounded. A first capacitor (C1) is connected in parallel with both ends of the first resistor (R1).

The connection between the first resistor (R1) and the second resistor (R2) is electrically connected with the converting input of the first voltage comparator (U1A). The connection between the first resistor (R1) and the second resistor (R2) is electrically connected with the converting input of the second voltage comparator (U1B).

The first input and the second input of the microprocessor (U3) respectively connect electrically with the output of the first voltage comparator (U1A) and the output of the second comparator (U1B).

The first output of the microprocessor (U3) is electrically connected, via resistor (R4), with the base electrode of the triode (Q1). The collector electrode of the triode (Q1) is electrically connected, via the coil of the contactor, to output of the step-down power supply (U4). Two ends of the coil of the contactor are connected in parallel in the reverse direction with the first diode (D1). The second output and the third output of the microprocessor (U3), which are used to output pulse signals, are respectively connected with the input of the first amplification circuit and the input of the second amplification circuit.

In applications, a liquid level control switch device of the invention can be fixed on a water pump. The outside electric power line connects with the T adaptor power line. The switch connector of the T adaptor connects with a liquid level control switch device. The power line o the pump connects to the output socket on the T adaptor. On the one hand, electric power line supplies power to the control circuit board in the switch device, to drive the control circuit board. On the other hand, the power line that drives the pump connects with the contactor in the switch device. The control circuit board controls the attraction or repulsion of the coil of the contactor, to automatically control the pump to achieve starting and stopping pumping water.

### BENEFICIAL EFFECTS OF THE INVENTION

Shortened cable length and reduced costs: Through the T adaptor of the invention, the power line of the water pump and power line of liquid level control switch device can share the same cable, effectively reducing the length of the cable that supplies power to the liquid level control switch device, achieving reduced costs.

Liquid level electrode and the control circuit board are encapsulated in a control switch device. This structure is more compact. At the same time, the distance between the induction electrode and the control circuit is shortened, avoiding the generation of incorrect signals by the control circuit due to electromagnetic interference.

A plastic partition (separation board) is arranged between the liquid level electrodes to prevent interference between the liquid level electrodes.

The liquid level electrodes are exposed outside the liquid level control switch device casing. This facilitates cleaning of the electrodes.

Electrolytic corrosion of the liquid level electrode can be reduced, by periodically sending sampling pulse signals to the liquid level electrode and collecting the liquid level signals from the liquid level electrodes. This ensures that the sampling requirements are met and can also effectively reduce the electrolytic corrosion of induction electrodes.

### BRIEF DESCRIPTION OF THE DRAWINGS

FIG. 1 is a schematic of a liquid level control switch device in accordance with embodiments of the invention.

FIG. 2 is a schematic of a T adaptor.

FIG. 3 is a schematic illustrating the internal connections of the T adaptor.

FIG. 4 illustrates the block diagram of a control circuit board in accordance with embodiments of the invention.

FIG. 5 is a schematic illustrating circuit diagram of a control circuit board of the invention for signal collection.

FIG. 6 shows a schematic illustrating the connection of a microprocessor in accordance with embodiments of the invention.

In the Figures, 1, liquid electrode; 11, first electrode; 12, second electrode; 13, third electrode; 2, casing; 21, first installation hole; 22 second installation hole; 23, third installation hole; 24, plastic partition; 3, control circuit board; 4, electric power lead wire; 41, first conductor; 42, second conductor; 43, third conductor, 5, T adaptor, 51, power line connection; 52, switch connection; 53, output socket; U1A, first voltage comparator; U1B, second voltage comparator, U2A, first operational amplifier; and U2B, second operational amplifier.

### DETAILED DESCRIPTION

In order to illustrate embodiments of the invention and technical objectives, the following further describes the invention using a combination of drawings and specific examples.

### Example 1

### A Liquid Level Control Switch Device

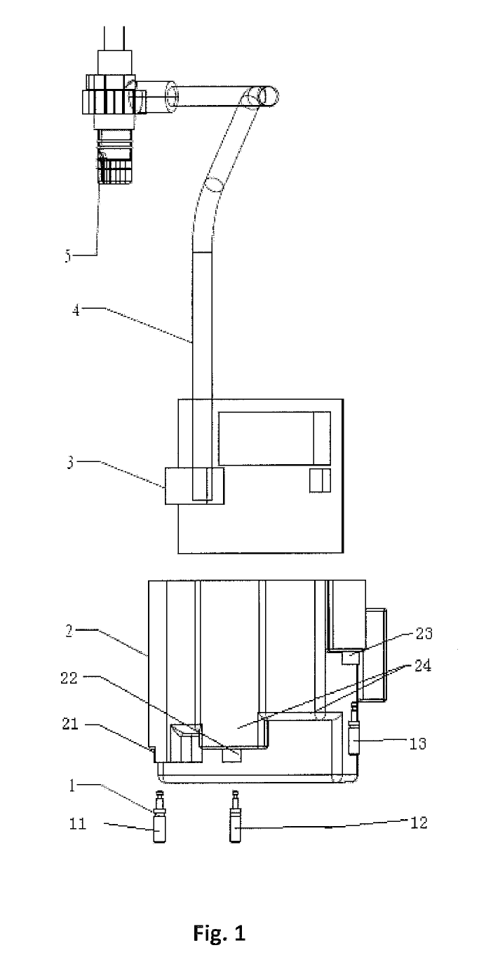

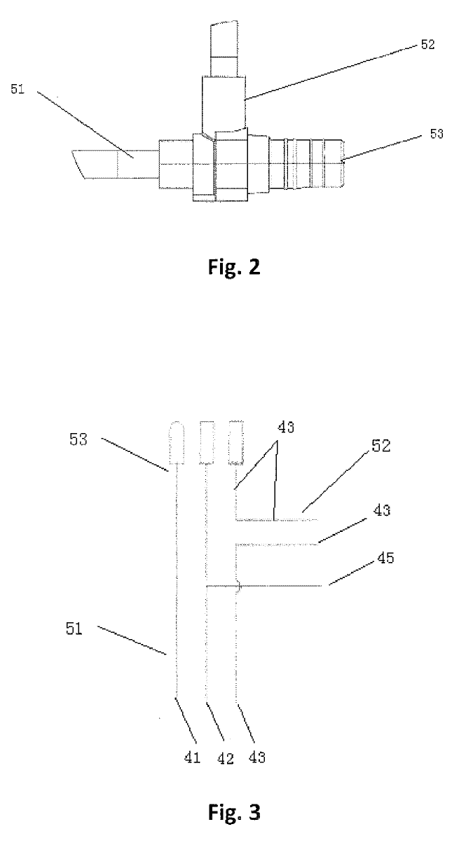

As shown in FIG. 1-FIG. 3, a liquid level control switch device of the invention comprises a liquid level sensor, a contactor and a T adaptor (5). The liquid level sensor comprises a liquid level electrode (1), a casing (housing) (2), a control circuit board (3), and a power supply lead wire (4). The casing (2) comprises a chamber having a bottom, a side wall, and an open top. The control circuit board (3) is disposed in the casing 2. One side of the lower portion of casing (2) is provided with a first installation hole (21), a second installation hole (22), and a third installation hole (23) for installing liquid level electrodes. The liquid level electrode (1) used for sensing liquid levels includes a high liquid level sensing a first electrode (11), a second electrode (12) for low liquid level sensing, and a third electrode (13) for connecting with a common connection point. The first, second, and third electrodes (11, 12, and 13) may be made of stainless steel, the diameters of which may be 3 mm, or may be 5 mm or 4 mm. A partial length of each of the first electrode (11), the second electrode (12), and the third electrode (13) is respectively sealingly installed in the first installation hole (21), the second installation hole (22), and third installation hole (23), respectively. The liquid level electrode (1) is exposed outside of the casing (2) to a length of 2 mm, or 7 mm or 6 mm. That the liquid level electrode is exposed outside the casing of the liquid level control switch device makes it easy to clean. The first electrode (11), the second electrode (12), and, the third electrodes (13) are electrically connected with the control circuit board (3). The first electrode (11), the liquid being sensed, and the third electrode (13) form a conductive loop. The second electrode (12), the liquid being sensed, and the third electrode (13) form a conductive loop. The control circuit board (3), in accordance with the sampling frequency (e.g., 3 times per second), sends the measurement signals to the first electrode (11) and the second electrode (12), and collects the liquid level signals sensed by the first electrode (11) and the second electrode (12), i.e., collects liquid level signals 3 times corresponding to the sampling frequency. The control circuit board (3) periodically sends sampling signal pulses to the liquid level electrodes, and collects the liquid level signals from the liquid level electrodes. In this way, it not only ensures meeting the sampling requirements, but also effectively reduces electrolytic corrosion of induction electrodes caused by the sampling signals. A plastic separator (partition) (24) is disposed between the first electrode (11) and the second electrode (12) to prevent interference. Plastic partition(s) may also be arranged between/among the liquid level electrodes to prevent the interference between the liquid level electrodes and to improve the measurement accuracy. The control circuit board (3) connects with the power supply lead wire, via the T adaptor. The contactor is arranged in the casing (2). The coil of the contactor is electrically connected with the control circuit board (3). The control circuit board (3) controls the closing and opening operations of the contactor, according to the first the liquid level signals collected by the first electrode (11) and the second electrode (12). When the liquid level is higher than the first electrode (11), the contactor is attracted to close, power is supplied to the pump, and the pump starts to work. When the liquid level is lower than the second electrode (12), the contactor disconnects (opens/breaks the conductive path), the power supply to the water pump is cutoff; and the water pump stops working. When the liquid level is between the first electrode (11) and the second electrode (12), the contactor opens, and the water pump stops working.

T adaptor (5): the T adaptor (5) includes a power line connecting part (51), a switch connecting part (52), and an output socket (53). Inside the T adaptor are provided with a first conductor (41), serving as a common ground, a second conductor (42), serving as a null line, at least one third conductor (43), serving as a live wire, at least one fourth conductor (44), serving as a live wire, and a fifth conductor (45) serving as a null line. The first conductor (41) and the second conductor (42) run through the power line connecting part (51) and the output socket (53). The third conductor (43) runs through the power line connecting part (51) and the switch connecting part (52). The fourth conductor (44) runs through the switch connecting part (52) and the output switch socket (53). The fifth conductor (45) and the second conductor (42) run through the switch connecting part (52). The switch connecting part (52) of the T adaptor (5) is electrically connected with the power supply lead wire (4) of the liquid level sensor. The third conductor (43) in the switch connecting part (52) is connected with the third conductor (44) and the contactor.

An external power supply is connected with the electric wire connecting part (51) of the T adaptor (5). The switch connecting part (52) in the T adaptor (5) is electrically connected with the liquid level sensor, to provide power to the liquid level sensor and drive the liquid level sensor. The output socket (53) of the T adaptor (5) is connected with the external control target, the water pump, to drive the water pump. By using the T adaptor (5), one can effectively eliminate one power cable that provides power to the liquid level control switch device, thereby reducing the costs.

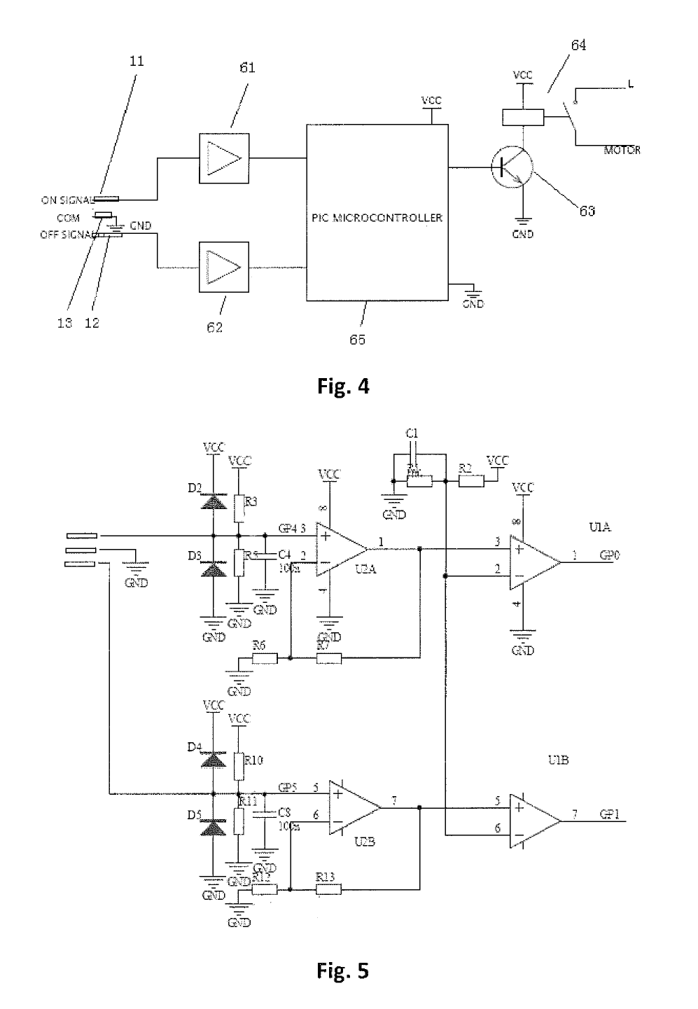

In such an embodiment, the control circuit board (3) is provided with a step-down power supply (VCC), a first amplification circuit (61), a second amplification circuit (62), a microprocessor (65), a triode (63), and a contactor (64), as shown in FIG. 4. The step-down power supply (VCC) provides power to the first amplification circuit (61), the second amplification circuit (62), the microprocessor (65), and the triode (63). The first electrode (11) that is used for sensing the high liquid level is electrically connected with the input of the first amplification circuit (61). The output of the first amplification circuit (61) is electrically connected with the first input of the microprocessor (65). The second electrode (12) that is used for low liquid level sensing is electrically connected with the input of the second amplification circuit (62). The output of the second amplification circuit (62) is electrically connected with the second input of the microprocessor (65). The first output of the microprocessor (65) is electrically connected with the base electrode of the triode (63). The collector electrode of the triode (63) is electrically connected, via the coil of the contactor (64), with the step-down power supply (VCC). The second output and the third output, which are used for transmitting pulse signals, of the microprocessor (65) are respectively connected with the input of the first amplification circuit (61) and the input of the second amplification circuit (62).

In such an embodiment, the first amplification circuit (61) includes a first operational amplifier (U2A) and a first voltage comparator (U1A). The output of the first operational amplifier (U2A) and the non-inverting input off the first voltage comparator (U1A) are electrically connected, as shown in FIG. 5.

The second diode D2 and the third diode D3 are connected in series in the same direction. The cathode of the second diode D2 and the third diode D3 is electrically connected with the output of the step-down power supply. The anode of the second diode D2 and the third diode D3 is grounded. Both ends of the second diode D2 and the third diode D3 are separately connected in parallel with the third resistor (R3) and the fifth resistor (R5). The connection between the second diode D2 and the third diode D3 is grounded via the fourth capacitor (C4). The input of the first amplification circuit (61) is electrically connected, via the connection between the second diode D2 and the third diode D3 is, with the non-inverting input of the first operational amplifier (U2A).

The seventh resistor (R7) and the sixth resistor (R6) are connected in series, one end of which is electrically connected with the output of the first operational amplifier (U2A), and the other end of which is grounded. The connection between the seventh resistor (R7) and the sixth resistor (R6) is electrically connected with the inverting input of the first operational amplifier (U2A).

The first resistor (R1) and the second resistor (R2) are connected in series. The other end of the second resistor (R2) is electrically connected with the output of the step-down power supply. The other end of the first resistor (R1) is grounded. Two ends of the first capacitor (C1) are connected in parallel to the first resistor R1. The connection between the first resistor (R1) and the second resistor (R2) is electrically connected with the inverting input of the first voltage comparator (U1A).

In such an embodiment, the second amplification circuit (62) includes a second operational amplifier (U2B) and a second voltage comparators (U1B). The output of the second operational amplifier (U2B) is electrically connected with the non-inverting input of the second voltage comparator (U1B), as shown in FIG. 5.

The fourth diode (D4) and the fifth diode (D5) are connected in series in the same direction. The cathode of the fourth diode (D4) and the fifth diode (D5) us electrically connected with the output of the step-down power supply, and the anode of the fourth diode (D4) and the fifth diode (D5) is grounded. The two ends of the fourth diode (D4) and the fifth diode (D5) are separately connected in parallel with the tenth resistor (R10) and the eleventh resistor (R11). The connection between the fourth diode (D4) and the fifth diode (D5) is grounded via the eighth capacitor (C8). The input of the second amplification circuit (62) is electrically connected, via the connection between the fourth diode (D4) and the fifth diode (D5), with the non-inverting input of the second operational amplifier (U2B).

The thirteenth resistor (R13) and the twelfth resistor (R12) are connected in series. One end of the thirteenth resistor (R13) and the twelfth resistor (R12) is electrically connected with output of the second operational amplifier (U2B). The other end of the thirteenth resistor (R13) and the twelfth resistor (R12) is grounded. The connection between the thirteenth resistor (R13) and the twelfth resistor (R12) is electrically connected with the inverting input of the second operational amplifier (U2B).

The connection between the first resistor (R1) and the second resistor (R2) is electrically connected with the inverting input of the second voltage comparator (U1B).

### Example 2

### Control Circuit

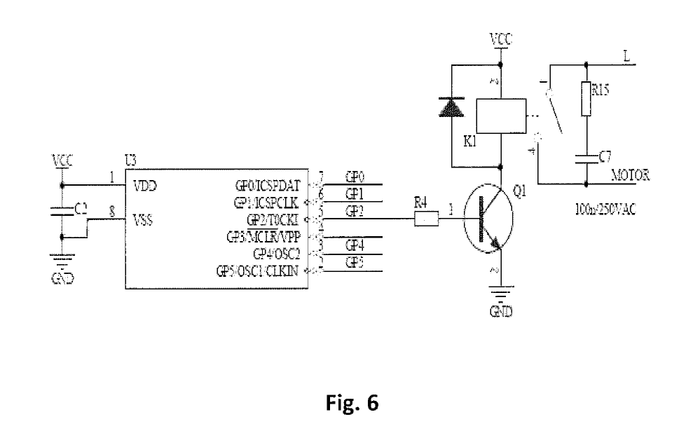

As shown in FIG. 5 and FIG. 6, the present invention provides a control circuit for a liquid level control switch device. The design features include: a first operational amplifier (U2A), a first voltage comparator (U1A), a second operational amplifier (U2B), a second voltage comparator, (U1B), a microprocessor (U3), a triode (Q1), and a step-down power supply (U4).

In order to clearly describe the principles of a control circuit of the invention and its connection relationship, in this example, the hardware parts mainly use the operational amplifier chip LM358, the voltage comparator chip LM393 and the microprocessor chip PIC12F509T. The operational amplifier chip LM358 forms the first operation amplifier (U2A) and the second operational amplifier (U2B). The voltage comparator chip LM393 forms the first voltage comparator (U1A) and the second voltage comparators (U1B). The microprocessor chip PIC12F509T is used for transmitting the measurement pulse signals and for collecting and processing the liquid level signals.

As shown in FIG. 5, the second diode (D2) and the third diode (D3) are connected in series in the same direction. Cathode of the second diode (D2) and the third diode (D3) is electrically connected with output of the step-down power supply. Anode of the second diode (D2) and the third diode (D3) is grounded. The two ends of the second diode (D2) and the third diode (D3) are separately connected in parallel with the third resistor (R3) and the fifth resistor (R5). The connection between the second diode (D2) and the third diode (D3) is grounded via the fourth capacitor (C4). The input of the first amplification circuit, which is used with the first electrode (11) that is used to sense the high fluid level, is electrically connected, via the connection between the second diode (D2) and the third diode (D3), with the third leg on the operational amplifier chip LM358 that forms the non-inverting input of the first operational amplifier (U2A).

The seventh resistor (R7) and the sixth resistor (R6) are connected in series. One end of the seventh resistor (R7) and the sixth resistor (R6) is electrically connected with the first leg of the operational amplifier chip LM358 that forms the output of the first operational amplifier (U2A). The other end of seventh resistor (R7) and the sixth resistor (R6) is grounded. The connection between seventh resistor (R7) and the sixth resistor (R6) is electrically connected with the second leg of the operational amplifier chip LM358 that forms the inverting input of the first operation amplifier (U2A). The first leg of the operational amplifier chip LM358, which forms the output of the first operational amplifier, is electrically connected with the third leg of the operational amplifier chip LM358, which forms the non-inverting input of the first voltage comparator (U1A).

As shown in FIG. 5, the fourth diode (D4) and the fifth diode (D5) are connected in series in the same direction. Cathode of the fourth diode (D4) and the fifth diode (D5) is electrically connected with the output of the step-down power supply. Anode of the fourth diode (D4) and the fifth diode (D5) is grounded. The two ends of the fourth diode (D4) and the fifth diode (D5) are separately connected in parallel with the tenth resistor (R10) and the eleventh resistor (R11). The connection between the fourth diode (D4) and the fifth diode (D5) is grounded via the eighth capacitor (C8). The unput of the second amplification circuit, which is used with the second electrode (12) that sense the low fluid level, is electrically connected with the fifth leg of the operational amplifier chip LM358 that forms the non-inverting input of the second operational amplifier (U2B).

The thirteenth resistor (R13) and the twelfth resistor (R12) are connected in series. One end of the thirteenth resistor (R13) and the twelfth resistor (R12) is electrically connected with the seventh leg of the operational amplifier chip LM358 that forms the output of the second operational amplifier (U2B). The other end of the thirteenth resistor (R13) and the twelfth resistor (R12) is grounded. The connection between the thirteenth resistor (R13) and the twelfth resistor (R12) is electrically connected with the sixth leg of the operational amplifier chip LM358 that forms the inverting input of the second operational amplifier (U2B). The seventh leg of the operational amplifier chip LM358, which forms the output of the second operational amplifier (U2B), is electrically connected with the fifth leg of the operational amplifier chip LM358, which forms the non-inverting input of the second voltage comparator (U1b).

The first resistor (R1) and the second resistor (R2) are connected in series. The other end of the second resistor (R2) is connected with the output of the step-down power supply. The other end of the first resistor (R1) is grounded. A first capacitor (C1) is connected in parallel with the two ends of the first resistor (R1). The connection between the first resistor (R1) and the second resistor (R2) is electrically connected with the second leg of the voltage comparator chip LM393, which forms the non-inverting input of the first voltage comparator (U1A). The connection between the first resistor (R1) and the second resistor (R2) is electrically connected with the sixth leg of the voltage comparator chip LM393, which forms the inverting input of the second voltage comparator (U1B).

The seventh leg of the voltage comparator chip LM393, which forms the first input of the microprocessor (U3), and the sixth leg of the voltage comparator chip LM393, which forms the second input of the microprocessor (U3), are separately connected with the first leg the voltage comparator chip LM393, which forms the output of the first voltage comparator (U1A) and the seventh leg of the voltage comparator chip LM393, which forms the output of the second voltage comparator (U1B).

The fifth leg of the voltage comparator chip LM393, which forms the first output of the microprocessor (U3) is electrically connected, via the fourth resistor (R4), with the base electrode of the triode (Q1). The triode is the model S-8050. The collector electrode of the triode (Q1) is electrically connected, via the coil of the contactor, with the output of the step-down power supply. The two ends of the coil of the contactor are connected in parallel in the reversed direction with the first diode (D1). The third leg that forms the second output of the microprocessor for transmitting the pulse signals and the second leg that forms the third output of the microprocessor are separately electrically connected with the third leg of the operational amplifier chip LM358 that forms the input of the first amplification circuit and the fifth leg of the operational amplification chip LM358 that forms the input of the second amplification circuit, i.e., separately connected with the first electrode (11) and the second electrode (12), to transmit pulse sampling signals to the first electrode (11) and the second electrode (12) to collect fluid level signals. Embodiments of the invention periodically send pulse sampling signals to the fluid level electrodes, to collect fluid level signals. This ensures that the sampling requirements are met and also can effectively reduce electrolytic corrosion of the capacitor electrodes caused by the sampling signals. In this particular example, the sampling frequency is 3 times per second.

In applications, a fluid level control switch device may be fixed on a water pump. The external power supply wire may be connected with the power line connecting part of the T adaptor (5). The switch connection part of the T adaptor is electrically connected with the fluid level sensor to provide power to the fluid level sensor and drive the operation of the fluid level sensor. The output socket of the T adaptor is electrically connected with the external target, the water pump, to drive the pumping. When the fluid level is higher than the first electrode (11), the contactor closes and supplies power to the water pump, causing the water pump to work. When the fluid level is lower than the second electrode (12), the contactor opens, cutting off power to the water pump, resulting in stoppage of the water pump. When the fluid level is between the first electrode (11) and the second electrode (12), the contactor opens and the water pump stops. This can automatically control the water pump, achieving starting pumping water or stopping pumping water.

Relative to the existing technology, embodiments of the invention has the following technical improvements:
1) Shorter cable length and reduced costs: using a T adaptor of the invention, the power line providing power to the water pump and the power supply line to the fluid level control switch device can share the same wire, effectively eliminating one cable used to provide power to the fluid level control switch device, resulting in reduced costs.
2) Fluid level electrodes and the control circuit board are enclosed in the control switch device. The structure is more compact, and distance between the sensing electrode and the control circuit is shortened. This can avoid incorrect signals due to electromagnetic interference of the control circuit.
3) Fluid level electrodes are separated by plastic separators, preventing interference between the fluid level electrodes.
4) The fluid level electrodes are exposed outside the casing of the fluid level control switch device, facilitating electrode cleaning.
5) Reduced electrolytic corrosion to the fluid level electrodes. By sending periodical pulse sampling signals to the fluid level electrodes and collect fluid level signals from the fluid level electrodes, one can ensure meeting the sampling requirements and at the same time effectively reducing electrolytic corrosion of the capacitive electrodes.

The above illustrates and describes the basic principles, main characteristics and advantages of the invention. One of ordinary skills in the field would understand that the invention is not limited by the above described examples. The above examples and description are only used to explain the principles of the invention. Various modifications and improvements to the invention are possible without departing from the scope of the invention. The protection scopes of the invention should be defined by the attached claims, the description, and any equivalents.

1. A liquid level control switch device, comprising
a liquid level sensor and
a contactor,
wherein the liquid level sensor comprises
a liquid level electrode,
a casing,
a control circuit board, and
a power supply lead wire;
wherein the casing comprises a chamber body having a bottom, a side wall, and an open top,
wherein the control circuit board is sealingly disposed inside the casing;
wherein a lower portion of the casing is provided with a first installation hole, a second installation hole and the third installation hole for installations of for liquid level electrodes;
wherein the liquid level electrode for sensing liquid levels comprises a first electrode for sensing high liquid level, a second electrode for sensing low liquid level, and a third electrode for connection a common terminal;
wherein a partial length of each of the first electrode, the second electrode and the third electrode are separately sealing arranged in the first installation hole, second installation hole, and the third installation hole;
wherein the first electrode, the second electrode, the third electrode, and the control circuit board are electrically connected;
wherein the control circuit board sends, according to sampling frequencies, measurement signals to the first electrode and the second electrode, and collects liquid level signals sensed by the first electrode and the second electrode;
wherein a plastic separation board is disposed between the first electrode and the second electrode to prevent electromagnetic interference;
wherein the control circuit board and the power supply lead wire are electrically connected;
wherein the contactor is disposed in the casing, and a coil of the contactor is electrically connected with the control circuit board; and
wherein the control circuit board controls the closing and opening operations of the contactor, according to the liquid level signals collected by the first electrode and the second electrode.

2. The liquid level control switch device according to claim 1, wherein the liquid level control switch device further comprises a T adaptor,
wherein said T adaptor comprises an electric wire connector, a switch connector, and an output socket,
wherein a first conductor that serves as a common ground, a second conductor serving as a null line, at least one third conductor serving as a live wire, at least one fourth conductor serving as a live wire, and a fifth conductor serving as a null line are disposed in the T-shaped connector;
wherein the first conductor, and the second conductor pass through the electric wire connector and the output socket;
wherein the third conductor pass through the electric wire connector and the switch connector;
wherein the fourth conductor pass through the switch connector and the output socket;
wherein the fifth conductor and the second conductor are electrically connected and pass through the switch connector;
wherein the switch connector of the T adaptor and the power supply lead wire of the liquid level sensor are electrically connected; and
wherein the third conductor and the fourth conductor in the switch connector connects with the contactor.

3. The liquid control switch according to claim 2, wherein the liquid level electrode is made of stainless steel.

4. The liquid control switch according to claim 2, wherein the liquid level electrode has a diameter of 3-5 mm and a length exposed outside the casing is 2-7 mm.

5. The liquid control switch according to claim 1, wherein the control circuit board is provided with
a step-down power supply,
a first amplification circuit,
a second amplification circuit,
a microprocessor, and
a triode;
wherein the step-down power supply provides electric power to the first amplification circuit, the second amplification circuit, the microprocessor and the triode;
wherein the first electrode for high liquid level sensing and an input of the first amplification circuit are electrically connected;
wherein an output of the first amplification circuit is electrically connected with a first input of the microprocessor;
wherein the second electrode for low liquid level sensing is electrically connected with an input of the second amplification circuit;
wherein an output of the second amplification circuit is electrically connected with the second input of the microprocessor;
wherein a first input of the microprocessor is electrically connected with the triode;
wherein a collector of the triode is electrically connected with the step-down power supply via the coil of the contactor; and
wherein a second output and a third output of the first amplification circuit are used to output pulse signals and are, respectively, electrically connected with the input of the first amplification circuit and the input of the second amplification circuit.

6. The liquid level control switch device according to claim 5, wherein the first amplification circuit comprises
a first operational amplifier and
a first voltage comparator,
wherein an output of the first operational amplifier and the non-inverting input are electrically connected;
wherein a second diode and a third diode are connected in series in the same direction, wherein cathodes of the second diode and the third diode are electrically connected with output of the step-down power supply, and anodes of the second diode and the third diode are grounded,
wherein two ends of the second diode and the third diode are connected in parallel with a third resistor and a fifth resistor, respectively,
wherein the connection between the second diode and the third diode is grounded via a fourth capacitor;
wherein input of the first amplification circuit is connected, via the connection between the second diode and the third diode, with the non-inverting input of the first operational amplifier;
wherein a seventh resistor is connected in series with a sixth resistor, and wherein one end of the seventh resistor and the sixth resistor is connected with an output of the first operational amplifier and the other end of the seventh resistor and the sixth resistor is grounded; the connection between the seventh resistor and the sixth resistor is electrically connected with an inverting input of the first operational amplifier;
wherein the first resistor and the second resistor are connected in series, and wherein the other end of the second resistor is connected with output of the step-down power supply, and the other end of the first resistor is grounded;
wherein a first capacitor is connected with both ends of the first resistor in parallel; and
wherein the connection between the first resistor and the second resistor is connected with the inverting input of the first voltage comparator.

7. The liquid level control switch device according to claim 6, wherein the second amplification circuit comprises
a second operational amplifier and
a second voltage comparator,
wherein the output of the second operational amplifier is electrically connected with a non-inverting input of the second voltage comparator;
wherein the fourth diode and the fifth diode are connected in series in the same direction, and wherein cathode of the fourth diode and the fifth diode is connected with output of the step-down power supply and anode of the fourth diode and the fifth diode is grounded;
wherein both ends of the fourth diode and the fifth diode are respectively connected in parallel to a tenth resistor and an eleventh resistor;
wherein the connection between the fourth diode and the fifth diode is grounded via an eighth capacitor;
wherein input of the second amplification circuit is electrically connected, via the connection between the fourth diode and the fifth diode, with the non-inverting input of the second operational amplifier;
wherein the thirteenth resistor and the twelfth resistor are connected in series, and one end of the thirteenth resistor and the twelfth resistor is electrically connected with output of the second operational amplifier, and the other end of the thirteenth resistor and the twelfth resistor is grounded, wherein the connection between the thirteenth resistor and the twelfth resistor is electrically connected with the inverting input of the second operational amplifier; and
wherein the connection between the first resistor and the second resistor is electrically connected with the inverting input of the second voltage comparator.

8. A liquid level control switch device, wherein the device comprising
a first operational amplifier,
a first voltage comparator,
a second operational amplifier,
a second voltage comparator,
a microprocessor,
a triode, and
a step-down power supply,
wherein the second diode and the third diode are connected in series in the same direction, cathode of the second diode and the third diode is electrically connected with output of the step-down power supply, and anode of the second diode and the third diode is grounded;
wherein two ends of the second diode and the third diode are respectively connected in parallel with the third resistor and the fifth resistor, the connection between the second diode and the third diode is grounded via the fourth capacitor;
wherein input of the first amplification circuit is electrically connected, via the connection between the second diode and the third diode, with the non-inverting input of the first operational amplifier;
wherein the seventh resistor and the sixth resistor are connected in series, one end of the seventh resistor and the sixth resistor is electrically connected with output of the first operational amplifier, the other end of the seventh resistor and the sixth resistor is grounded, the connection between the seventh resistor and the sixth resistor is electrically connected with the inverting input of the first operational amplifier;
wherein output of the first operational amplifier is electrically connected with non-inverting input of the first voltage comparator;
wherein the fourth diode and the fifth diode are connected in series in the same direction, cathode of the fourth diode and the fifth diode is electrically connected with output of the step-down power supply, anode of the fourth diode and the fifth diode is grounded;
wherein two ends of the fourth diode and the fifth diode are respectively connected in parallel with the tenth resistor and the eleventh resistor, the connection between the fourth diode and the fifth diode is grounded via the eight capacitor;
wherein input of the second amplification circuit is electrically connected, via the connection between the fourth diode and the fifth diode, with the non-inverting input of the second operational amplifier;
wherein the thirteenth resistor and the twelfth resistor are connected in series, one end of the thirteenth resistor and the twelfth resistor is electrically connected with output of the second operational amplifier, the other end of the thirteenth resistor and the twelfth resistor is grounded, the connection between the thirteenth resistor and the twelfth resistor is electrically connected with inverting input of the second operational amplifier;
wherein output of the second operational amplifier and non-inverting input of the second voltage comparator are electrically connected;
wherein the first resistor and the second resistor are connected in series, the other end of the second resistor is electrically connected with output of the step-down power supply, the other end of the first resistor is grounded, a first capacitor is connected in parallel to both ends of the first resistor;
wherein the connection between the first resistor and the second resistor is electrically connected with the converting input of the first voltage comparator, the connection between the first resistor and the second resistor is electrically connected with the converting input of the second voltage comparator;
wherein the first input and the second input of the microprocessor respectively connect electrically with output of the first voltage comparator and output of the second comparator; and
wherein the first output of the microprocessor is electrically connected, via resistor, with the base electrode of the triode, the collector electrode of the triode is electrically connected, via the coil of the contactor, to output of the step-down power supply, two ends of the coil of the contactor are connected in parallel in the reverse direction with the first diode, the second output and the third output of the microprocessor, which are used to emit pulse signals, are respectively connected with the input of the first amplification circuit and the input of the second amplification circuit.

9. The liquid control switch according to claim 2, wherein the control circuit board is provided with
a step-down power supply,
a first amplification circuit,
a second amplification circuit,
a microprocessor, and
a triode;
wherein the step-down power supply provides electric power to the first amplification circuit, the second amplification circuit, the microprocessor and the triode;
wherein the first electrode for high liquid level sensing and an input of the first amplification circuit are electrically connected;
wherein an output of the first amplification circuit is electrically connected with a first input of the microprocessor;
wherein the second electrode for low liquid level sensing is electrically connected with an input of the second amplification circuit;
wherein an output of the second amplification circuit is electrically connected with the second input of the microprocessor,
wherein a first input of the microprocessor is electrically connected with the triode;
wherein a collector of the triode is electrically connected with the step-down power supply via the coil of the contactor; and
wherein a second output and a third output of the first amplification circuit are used to output pulse signals and are, respectively, electrically connected with the input of the first amplification circuit and the input of the second amplification circuit.

10. The liquid control switch according to claim 3, wherein the control circuit board is provided with
a step-down power supply,
a first amplification circuit,
a second amplification circuit,
a microprocessor, and
a triode;
wherein the step-down power supply provides electric power to the first amplification circuit, the second amplification circuit, the microprocessor and the triode;
wherein the first electrode for high liquid level sensing and an input of the first amplification circuit are electrically connected;
wherein an output of the first amplification circuit is electrically connected with a first input of the microprocessor;
wherein the second electrode for low liquid level sensing is electrically connected with an input of the second amplification circuit;
wherein an output of the second amplification circuit is electrically connected with the second input of the microprocessor;
wherein a first input of the microprocessor is electrically connected with the triode;
wherein a collector of the triode is electrically connected with the step-down power supply via the coil of the contactor; and
wherein a second output and a third output of the first amplification circuit are used to output pulse signals and are, respectively, electrically connected with the input of the first amplification circuit and the input of the second amplification circuit.

11. The liquid control switch according to claim 4, wherein the control circuit board is provided with
a step-down power supply,
a first amplification circuit,
a second amplification circuit,
a microprocessor, and
a triode;
wherein the step-down power supply provides electric power to the first amplification circuit, the second amplification circuit, the microprocessor and the triode;
wherein the first electrode for high liquid level sensing and an input of the first amplification circuit are electrically connected;
wherein an output of the first amplification circuit is electrically connected with a first input of the microprocessor;
wherein the second electrode for low liquid level sensing is electrically connected with an input of the second amplification circuit;
wherein an output of the second amplification circuit is electrically connected with the second input of the microprocessor;
wherein a first input of the microprocessor is electrically connected with the triode;
wherein a collector of the triode is electrically connected with the step-down power supply via the coil of the contactor; and
wherein a second output and a third output of the first amplification circuit are used to output pulse signals and are, respectively, electrically connected with the input of the first amplification circuit and the input of the second amplification circuit.

12. The liquid level control switch device according to claim 9, wherein the first amplification circuit comprises
a first operational amplifier and
a first voltage comparator,
wherein an output of the first operational amplifier and the non-inverting input are electrically connected;
wherein a second diode and a third diode are connected in series in the same direction, wherein cathodes of the second diode and the third diode are electrically connected with output of the step-down power supply, and anodes of the second diode and the third diode are grounded,
wherein two ends of the second diode and the third diode are connected in parallel with a third resistor and a fifth resistor, respectively,
wherein the connection between the second diode and the third diode is grounded via a fourth capacitor;
wherein input of the first amplification circuit is connected, via the connection between the second diode and the third diode, with the non-inverting input of the first operational amplifier;
wherein a seventh resistor is connected in series with a sixth resistor, and wherein one end of the seventh resistor and the sixth resistor is connected with an output of the first operational amplifier and the other end of the seventh resistor and the sixth resistor is grounded; the connection between the seventh resistor and the sixth resistor is electrically connected with an inverting input of the first operational amplifier;
wherein the first resistor and the second resistor are connected in series, and wherein the other end of the second resistor is connected with output of the step-down power supply, and the other end of the first resistor is grounded;
wherein a first capacitor is connected with both ends of the first resistor in parallel; and
wherein the connection between the first resistor and the second resistor is connected with the inverting input of the first voltage comparator.

13. The liquid level control switch device according to claim 10, wherein the first amplification circuit comprises
a first operational amplifier and
a first voltage comparator,
wherein an output of the first operational amplifier and the non-inverting input are electrically connected;
wherein a second diode and a third diode are connected in series in the same direction, wherein cathodes of the second diode and the third diode are electrically connected with output of the step-down power supply, and anodes of the second diode and the third diode are grounded,
wherein two ends of the second diode and the third diode are connected in parallel with a third resistor and a fifth resistor, respectively,
wherein the connection between the second diode and the third diode is grounded via a fourth capacitor,
wherein input of the first amplification circuit is connected, via the connection between the second diode and the third diode, with the non-inverting input of the first operational amplifier;
wherein a seventh resistor is connected in series with a sixth resistor, and wherein one end of the seventh resistor and the sixth resistor is connected with an output of the first operational amplifier and the other end of the seventh resistor and the sixth resistor is grounded; the connection between the seventh resistor and the sixth resistor is electrically connected with an inverting input of the first operational amplifier;
wherein the first resistor and the second resistor are connected in series, and wherein the other end of the second resistor is connected with output of the step-down power supply, and the other end of the first resistor is grounded;
wherein a first capacitor is connected with both ends of the first resistor in parallel; and
wherein the connection between the first resistor and the second resistor is connected with the inverting input of the first voltage comparator.

14. The liquid level control switch device according to claim 11, wherein the first amplification circuit comprises
a first operational amplifier and
a first voltage comparator,
wherein an output of the first operational amplifier and the non-inverting input are electrically connected;
wherein a second diode and a third diode are connected in series in the same direction, wherein cathodes of the second diode and the third diode are electrically connected with output of the step-down power supply, and anodes of the second diode and the third diode are grounded,
wherein two ends of the second diode and the third diode are connected in parallel with a third resistor and a fifth resistor, respectively,
wherein the connection between the second diode and the third diode is grounded via a fourth capacitor;
wherein input of the first amplification circuit is connected, via the connection between the second diode and the third diode, with the non-inverting input of the first operational amplifier;
wherein a seventh resistor is connected in series with a sixth resistor, and wherein one end of the seventh resistor and the sixth resistor is connected with an output of the first operational amplifier and the other end of the seventh resistor and the sixth resistor is grounded; the connection between the seventh resistor and the sixth resistor is electrically connected with an inverting input of the first operational amplifier;
wherein the first resistor and the second resistor are connected in series, and wherein the other end of the second resistor is connected with output of the step-down power supply, and the other end of the first resistor is grounded;
wherein a first capacitor is connected with both ends of the first resistor in parallel; and
wherein the connection between the first resistor and the second resistor is connected with the inverting input of the first voltage comparator.

15. The liquid level control switch device according to claim 12, wherein the second amplification circuit comprises
a second operational amplifier and
a second voltage comparator,
wherein the output of the second operational amplifier is electrically connected with a non-inverting input of the second voltage comparator;
wherein the fourth diode and the fifth diode are connected in series in the same direction, and wherein cathode of the fourth diode and the fifth diode is connected with output of the step-down power supply and anode of the fourth diode and the fifth diode is grounded;
wherein both ends of the fourth diode and the fifth diode are respectively connected in parallel to a tenth resistor and an eleventh resistor;
wherein the connection between the fourth diode and the fifth diode is grounded via an eighth capacitor;
wherein input of the second amplification circuit is electrically connected, via the connection between the fourth diode and the fifth diode, with the non-inverting input of the second operational amplifier;
wherein the thirteenth resistor and the twelfth resistor are connected in series, and one end of the thirteenth resistor and the twelfth resistor is electrically connected with output of the second operational amplifier, and the other end of the thirteenth resistor and the twelfth resistor is grounded, wherein the connection between the thirteenth resistor and the twelfth resistor is electrically connected with the inverting input of the second operational amplifier; and
wherein the connection between the first resistor and the second resistor is electrically connected with the inverting input of the second voltage comparator.

16. The liquid level control switch device according to claim 13, wherein the second amplification circuit comprises
a second operational amplifier and
a second voltage comparator,
wherein the output of the second operational amplifier is electrically connected with a non-inverting input of the second voltage comparator;
wherein the fourth diode and the fifth diode are connected in series in the same direction, and wherein cathode of the fourth diode and the fifth diode is connected with output of the step-down power supply and anode of the fourth diode and the fifth diode is grounded;
wherein both ends of the fourth diode and the fifth diode are respectively connected in parallel to a tenth resistor and an eleventh resistor;
wherein the connection between the fourth diode and the fifth diode is grounded via an eighth capacitor;
wherein input of the second amplification circuit is electrically connected, via the connection between the fourth diode and the fifth diode, with the non-inverting input of the second operational amplifier;
wherein the thirteenth resistor and the twelfth resistor are connected in series, and one end of the thirteenth resistor and the twelfth resistor is electrically connected with output of the second operational amplifier, and the other end of the thirteenth resistor and the twelfth resistor is grounded, wherein the connection between the thirteenth resistor and the twelfth resistor is electrically connected with the inverting input of the second operational amplifier; and
wherein the connection between the first resistor and the second resistor is electrically connected with the inverting input of the second voltage comparator.

17. The liquid level control switch device according to claim 14, wherein the second amplification circuit comprises
a second operational amplifier and
a second voltage comparator,
wherein the output of the second operational amplifier is electrically connected with a non-inverting input of the second voltage comparator;
wherein the fourth diode and the fifth diode are connected in series in the same direction, and wherein cathode of the fourth diode and the fifth diode is connected with output of the step-down power supply and anode of the fourth diode and the fifth diode is grounded;
wherein both ends of the fourth diode and the fifth diode are respectively connected in parallel to a tenth resistor and an eleventh resistor;
wherein the connection between the fourth diode and the fifth diode is grounded via an eighth capacitor;
wherein input of the second amplification circuit is electrically connected, via the connection between the fourth diode and the fifth diode, with the non-inverting input of the second operational amplifier;
wherein the thirteenth resistor and the twelfth resistor are connected in series, and one end of the thirteenth resistor and the twelfth resistor is electrically connected with output of the second operational amplifier, and the other end of the thirteenth resistor and the twelfth resistor is grounded, wherein the connection between the thirteenth resistor and the twelfth resistor is electrically connected with the inverting input of the second operational amplifier; and
wherein the connection between the first resistor and the second resistor is electrically connected with the inverting input of the second voltage comparator.
